(19) United States
(12) Patent Application Publication
(10) Pub. No.: US 2026/0269131 A1
(43) Pub. Date: Sep. 10, 2026

(54) MULTILAYER CERAMIC CAPACITOR

(71) Applicant: Murata Manufacturing Co., Ltd., Nagaokakyo-shi (JP)

(72) Inventors: Keita AKASHI, Nagaokakyo-shi (JP); Toshihiko KOBAYASHI, Nagaokakyo-shi (JP)

(21) Appl. No.: 19/654,873

(22) Filed: Apr. 22, 2026

Related U.S. Application Data
(63) Continuation of application No. PCT/JP2025/008749, filed on Mar. 10, 2025.

(51) Int. Cl. H01G 4/232; H01G 4/005; H01G 4/12; H01G 4/248; H01G 4/30

(52) U.S. Cl. CPC H01G 4/2325; H01G 4/005; H01G 4/248; H01G 4/30; H01G 4/12

(57) ABSTRACT

A multilayer ceramic capacitor includes a multilayer body including dielectric layers, first and second inner electrode layers, and first and second outer electrodes. The first inner electrode layer includes a first exposed section. The second inner electrode layer includes a second exposed section. The first outer electrode and the second outer electrode each include Cu and Ag as metal components and a glass component. At least one of an interface between the first outer electrode and a third surface or an interface between the second outer electrode and a fourth surface is provided with a glass layer. At least one of a connection region between the first outer electrode and the first exposed section or a connection region between the second outer electrode and the second exposed section is provided with an Ag segregation section where an Ag particle is segregated.

### CROSS REFERENCE TO RELATED APPLICATIONS

This application is a Continuation application of PCT Application No. PCT/JP2025/008749 filed on Mar. 10, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

In the related art, a multilayer ceramic capacitor is known as a multilayer ceramic electronic component. Generally, a multilayer ceramic capacitor includes a multilayer body having multiple dielectric layers and multiple inner electrode layers alternately stacked one on top of the other, and a pair of outer electrodes provided at the surface of the multilayer body to electrically connect to an inner electrode extending to the surface of the multilayer body. The surface of each outer electrode is provided with Ni plating for preventing solder leaching during mounting, and is further provided with Sn plating on the Ni plating to improve solderability during solder mounting. The Ni plating, the Sn plating, and the like are normally formed by an electrolytic plating method.

Japanese Unexamined Patent Application Publication No. H01-80011 describes that hydrogen generated by a chemical reaction in a plating process is occluded in an inner electrode and that the occluded hydrogen gradually reduces a surrounding dielectric layer, thus causing problems such as deterioration of insulation resistance. As a solution, it is described that, when an inner electrode mainly composed of a noble metal (e.g., Ag—Pd alloy) is used, a metal (e.g., Ni) that suppresses hydrogen absorption is added to the inner electrode.

When a base electrode layer constituting each outer electrode of the multilayer ceramic capacitor is to be formed by baking, mutual diffusion between the base electrode layer including copper and the inner electrode including nickel causes the volume of the inner electrode to increase, thus causing a crack to occur.

### SUMMARY OF THE INVENTION

However, if the amount of heat applied during baking of the base electrode layer is reduced in order to suppress the mutual diffusion mentioned above, contact reliability between the inner electrode and the base electrode layer is adversely affected.

Example embodiments of the present invention provide multilayer ceramic capacitors each capable of achieving improved reliability by reducing or preventing mutual diffusion between an outer electrode and an inner electrode.

A multilayer ceramic capacitor according to an example embodiment of the present invention includes a multilayer body including a plurality of dielectric layers that are stacked and a plurality of inner electrode layers that are stacked on the dielectric layers, a first surface and a second surface that are opposed to each other in a stacking direction, a third surface and a fourth surface that are opposed to each other in a first direction orthogonal to the stacking direction, and a fifth surface and a sixth surface that are opposed to each other in a second direction orthogonal to the stacking direction and the first direction, a first inner electrode layer on the plurality of dielectric layers and extending to the third surface, a second inner electrode layer on the plurality of dielectric layers and extending to the fourth surface, a first outer electrode on the third surface and connected to the first inner electrode layer, and a second outer electrode on the fourth surface and connected to the second inner electrode layer. The first inner electrode layer includes a first exposed section exposed at the third surface. The second inner electrode layer includes a second exposed section exposed at the fourth surface. The first outer electrode and the second outer electrode each include Cu and Ag as metal components and a glass component. At least one of an interface between the first outer electrode and the third surface or an interface between the second outer electrode and the fourth surface is provided with a glass layer. At least one of a connection region between the first outer electrode and the first exposed section or a connection region between the second outer electrode and the second exposed section is provided with an Ag segregation section where an Ag particle is segregated.

With the multilayer ceramic capacitor according to this example embodiment of the present invention, at least one of the connection region between the first outer electrode and the first exposed section or the connection region between the second outer electrode and the second exposed section is provided with the Ag segregation section where the Ag particle is segregated, so that the amount of Cu that is included in the outer electrode and that is diffused to Ni included in the inner electrode layer is reduced during baking of the outer electrodes. Consequently, expansion of the inner electrode layer can be reduced or prevented to reduce or prevent cracks inside the multilayer body and also reduce hydrogen-induced deterioration of insulation resistance.

Example embodiments of the present invention provide multilayer ceramic capacitors each capable of achieving improved reliability by reducing or preventing mutual diffusion between an outer electrode and an inner electrode.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a two-terminal multilayer ceramic capacitor according to a first example embodiment of the present invention.

FIG. 2 is a cross-sectional view taken along line II-II in FIG. 1.

FIG. 3 is a cross-sectional view taken along line III-III in FIG. 1.

FIG. 4 is a cross-sectional view illustrating a modification of the structure of an interface area between a multilayer body and an outer electrode.

FIG. 5 is an external perspective view illustrating an example of a three-terminal multilayer ceramic capacitor according to a second example embodiment of the present invention.

FIG. 6 is a top view illustrating the example of the three-terminal multilayer ceramic capacitor according to the second example embodiment of the present invention.

FIG. 7 is a bottom view illustrating the example of the three-terminal multilayer ceramic capacitor according to the second example embodiment of the present invention.

FIG. 8 is a cross-sectional view taken along line VIII-VIII in FIG. 5.

FIG. 9 is a cross-sectional view taken along line IX-IX in FIG. 5.

### DETAILED DESCRIPTION OF THE EXAMPLE EMBODIMENTS

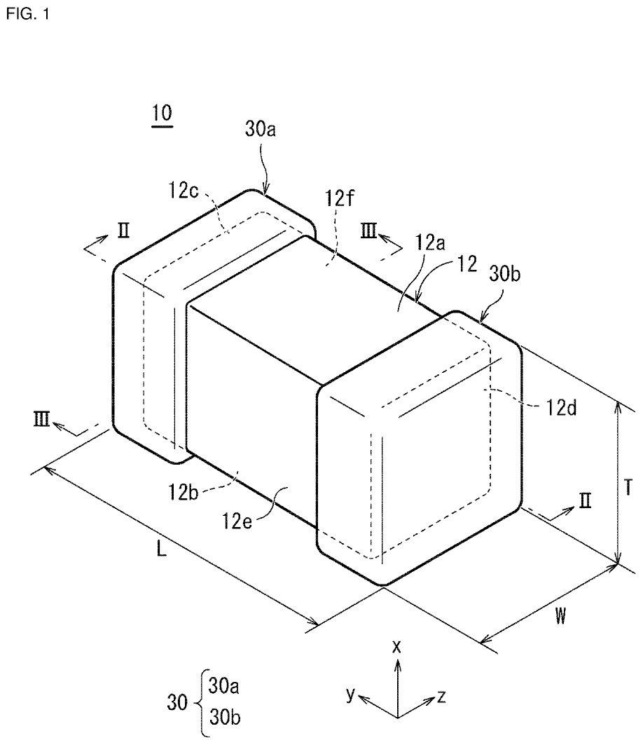

A two-terminal multilayer ceramic capacitor 10 will now be described as a multilayer ceramic capacitor according to a first example embodiment of the present invention with reference to FIG. 1 to FIG. 3.

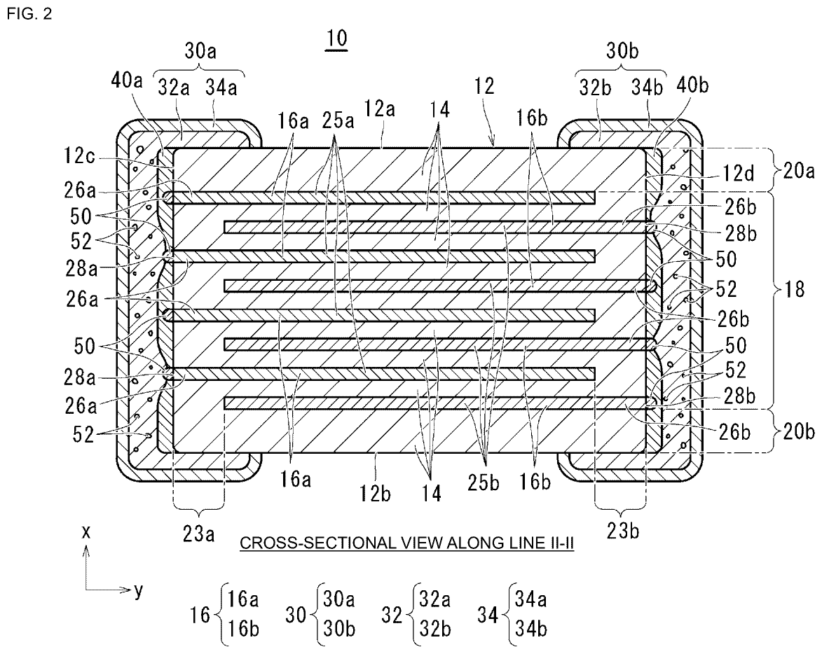

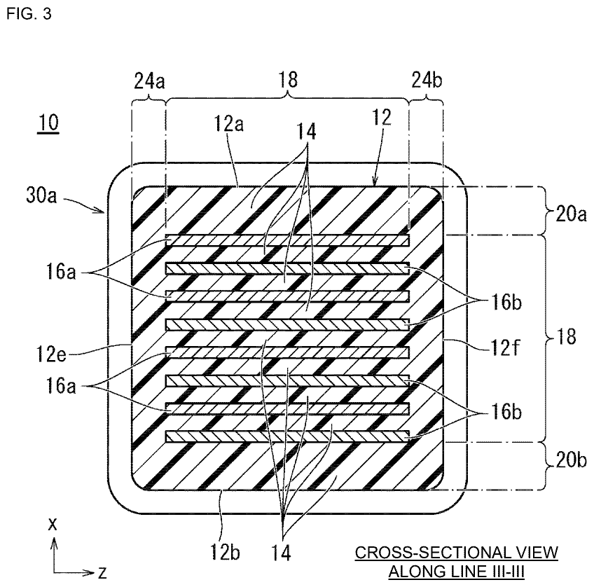

FIG. 1 is an external perspective view illustrating an example of the two-terminal multilayer ceramic capacitor according to the first example embodiment of the present invention. FIG. 2 is a cross-sectional view taken along line II-II in FIG. 1. FIG. 3 is a cross-sectional view taken along line III-III in FIG. 1.

As illustrated in FIG. 1 to FIG. 3, the two-terminal multilayer ceramic capacitor 10 includes a rectangular parallelepiped multilayer body 12 and an outer electrode 30 disposed at the surface of the multilayer body 12.

The multilayer body 12 includes multiple stacked dielectric layers 14 and multiple inner electrode layers 16 stacked on the dielectric layers 14. The inner electrode layers 16 include first inner electrode layers 16a and second inner electrode layers 16b. The first inner electrode layers 16a and the second inner electrode layers 16b will be described in detail later.

The multilayer body 12 has a first surface 12a and a second surface 12b that are opposed to each other in a stacking direction x, a third surface 12c and a fourth surface 12d that are opposed to each other in a first direction y orthogonal to the stacking direction x, and a fifth surface 12e and a sixth surface 12f that are opposed to each other in a second direction z orthogonal to the stacking direction x and the first direction y.

The multilayer body 12 has a rectangular parallelepiped shape, and the multilayer body 12 preferably includes rounded corners and edges. The corners are where three surfaces of the multilayer body 12 intersect, and the edges are where two surfaces of the multilayer body 12 intersect. The first surface 12a and the second surface 12b, the third surface 12c and the fourth surface 12d, and the fifth surface 12e and the sixth surface 12f may be partially or entirely provided with protrusions, recesses, and/or the like.

The multilayer body 12 includes a capacitance-generating section 18, a first outer layer section 20a located at the first surface 12a side, and a second outer layer section 20b located at the second surface 12b side. The first outer layer section 20a and the second outer layer section 20b are disposed to sandwich the capacitance-generating section 18 therebetween in the stacking direction x.

In the capacitance-generating section 18, the first inner electrode layers 16a and the second inner electrode layers 16b are alternately stacked with the dielectric layers 14 interposed therebetween.

The first outer layer section 20a is located at the first surface 12a side of the multilayer body 12, and is an aggregate of multiple dielectric layers 14 located between the first surface 12a and the capacitance-generating section 18 closest to the first surface 12a. The second outer layer section 20b is located at the second surface 12b side of the multilayer body 12, and is an aggregate of multiple dielectric layers 14 located between the second surface 12b and the capacitance-generating section 18 closest to the second surface 12b. Furthermore, a region interposed between the first outer layer section 20a and the second outer layer section 20b is the capacitance-generating section 18.

As illustrated in FIG. 2, the multilayer body 12 includes end portions (L-gaps) 23a and 23b of the multilayer body 12, which are located between the capacitance-generating section 18 and the third surface 12c and between the capacitance-generating section 18 and the fourth surface 12d.

Furthermore, as illustrated in FIG. 3, the multilayer body 12 includes side portions (W-gaps) 24a and 24b of the multilayer body 12, which are located between the capacitance-generating section 18 and the fifth surface 12e and between the capacitance-generating section 18 and the sixth surface 12f.

The dielectric layers 14 may include, for example, a dielectric material as a ceramic material. Such a dielectric material used may be, for example, a dielectric ceramic material including a component, such as BaTiO₃, CaTiO₃, SrTiO₃, or CaZrO₃. When the aforementioned dielectric material is included as a main component, a material to which a subcomponent having a smaller content than that of the main component, such as an Mn compound, an Fe compound, a Cr compound, a Co compound, or an Ni compound, is added may be used, depending on the desired characteristics of the multilayer body 12.

Each dielectric layer 14 in the multilayer body 12 after firing preferably has a thickness of about 0.4 μm or more and about 1.0 μm or less, for example.

The number of dielectric layers 14 stacked is preferably 50 or more and 1500 or less, for example. The number of dielectric layers 14 is a total of the number of dielectric layers 14 constituting the capacitance-generating section 18 and the number of dielectric layers in the first outer layer section 20a and the second outer layer section 20b.

The multilayer body 12 includes the multiple first inner electrode layers 16a and the multiple second inner electrode layers 16b as the multiple inner electrode layers 16. The multiple first inner electrode layers 16a and the multiple second inner electrode layers 16b are substantially parallel to the first surface 12a and the second surface 12b, and are embedded so as to be alternately arranged in the stacking direction x of the multilayer body 12 with the dielectric layers 14 interposed therebetween.

The first inner electrode layers 16a are disposed on the multiple dielectric layers 14 and are located within the multilayer body 12. The first inner electrode layers 16a include first counter electrode sections 25a facing the second inner electrode layers 16b, and first extraction electrode sections 26a located at one end of the first inner electrode layers 16a and extending from the first counter electrode sections 25a to the third surface 12c of the multilayer body 12. Thus, each of the multiple first extraction electrode sections 26a has a first exposed section 28a whose end portion extends to the third surface 12c and that is exposed from the multilayer body 12.

The shape of the first counter electrode section 25a of each first inner electrode layer 16a is not particularly limited, but is preferably rectangular in plan view. The corners in plan view may be rounded, or the corners may be formed obliquely (tapered) in plan view. A tapered shape in plan view that is sloped in either direction is also possible.

The shape of the first extraction electrode section 26a of each first inner electrode layer 16a is not particularly limited, but is preferably rectangular in plan view. The corners in plan view may be rounded, or the corners may be formed obliquely (tapered) in plan view. A tapered shape in plan view that is sloped in either direction is also possible.

The width of the first counter electrode section 25a of each first inner electrode layer 16a and the width of the first extraction electrode section 26a of each first inner electrode layer 16a may be equal to each other, or one of the widths may be smaller than the other.

The second inner electrode layers 16b are disposed on the multiple dielectric layers 14 and are located within the multilayer body 12. The second inner electrode layers 16b include second counter electrode sections 25b facing the first inner electrode layers 16a, and second extraction electrode sections 26b located at one end of the second inner electrode layers 16b and extending from the second counter electrode sections 25b to the fourth surface 12d of the multilayer body 12. Thus, each of the second extraction electrode sections 26b has a second exposed section 28b whose end portion extends to the surface of the fourth surface 12d and that is exposed from the multilayer body 12.

The shape of the second counter electrode section 25b of each second inner electrode layer 16b is not particularly limited, but is preferably rectangular in plan view. The corners in plan view may be rounded, or the corners may be formed obliquely (tapered) in plan view. A tapered shape in plan view that is sloped in either direction is also possible.

The shape of the second extraction electrode section 26b of each second inner electrode layer 16b is not particularly limited, but is preferably rectangular in plan view. The corners in plan view may be rounded, or the corners may be formed obliquely (tapered) in plan view. A tapered shape in plan view that is sloped in either direction is also possible.

The width of the second counter electrode section 25b of each second inner electrode layer 16b and the width of the second extraction electrode section 26b of each second inner electrode layer 16b may be equal to each other, or one of the widths may be smaller than the other.

In the multilayer body 12, the first counter electrode section 25a of each first inner electrode layer 16a and the second counter electrode section 25b of the corresponding second inner electrode layer 16b face each other. In this example embodiment, the first counter electrode section 25a of each first inner electrode layer 16a and the second counter electrode section 25b of the corresponding second inner electrode layer 16b face each other via the corresponding dielectric layer 14 such that electrostatic capacitance is generated and capacitor characteristics are exhibited.

Furthermore, by including Sn layers between the first inner electrode layers 16a and the dielectric layers 14 and between the second inner electrode layers 16b and the dielectric layers 14, electric-field concentration to the interfaces between the inner electrode layers 16 and the dielectric layers 14 can be mitigated to contribute to improved high-temperature load reliability.

The first inner electrode layers 16a and the second inner electrode layers 16b may each include, for example, an appropriate conductive material, such as a metal including Ni, Cu, Ag, Pd, or Au, or an alloy including at least one of these metals, such as an Ag—Pd alloy.

The thickness of each first inner electrode layer 16a is not particularly limited, but is preferably, for example, about 0.4 μm or more and about 1.0 μm or less.

The thickness of each second inner electrode layer 16b is not particularly limited, but is preferably, for example, about 0.4 μm or more and about 1.0 μm or less.

The total number of first inner electrode layers 16a and second inner electrode layers 16b is preferably 50 or more and 1500 or less, for example.

The number of first inner electrode layers 16a is not particularly limited, but is preferably, for example, 25 or more and 750 or less, for example.

The number of second inner electrode layers 16b is not particularly limited, but is preferably, for example, 25 or more and 750 or less, for example.

As illustrated in FIG. 1 to FIG. 3, the outer electrode 30 is provided at the third surface 12c side and the fourth surface 12d side of the multilayer body 12. The outer electrode 30 includes a first outer electrode 30a and a second outer electrode 30b.

The first outer electrode 30a is connected to the first inner electrode layers 16a and is disposed at least at the surface of the third surface 12c. The first outer electrode 30a also extends from the third surface 12c of the multilayer body 12 so as to be disposed at a portion of the first surface 12a, a portion of the second surface 12b, a portion of the fifth surface 12e, and a portion of the sixth surface 12f.

The second outer electrode 30b is connected to the second inner electrode layers 16b and is disposed at least at the surface of the fourth surface 12d. The second outer electrode 30b also extends from the fourth surface 12d of the multilayer body 12 so as to be disposed at a portion of the first surface 12a, a portion of the second surface 12b, a portion of the fifth surface 12e, and a portion of the sixth surface 12f.

The outer electrode 30 includes a base electrode layer 32 disposed at the surface of the multilayer body 12, and a plating layer 34 disposed to cover the base electrode layer 32.

The base electrode layer 32 includes a first base electrode layer 32a and a second base electrode layer 32b.

The plating layer 34 includes a first plating layer 34a and a second plating layer 34b.

In other words, the first outer electrode 30a includes the first base electrode layer 32a and the first plating layer 34a. The second outer electrode 30b includes the second base electrode layer 32b and the second plating layer 34b.

The first base electrode layer 32a is disposed at the third surface 12c of the multilayer body 12, and extends from the third surface 12c so as to partially cover the first surface 12a, the second surface 12b, the fifth surface 12e, and the sixth surface 12f.

The second base electrode layer 32b is disposed at the fourth surface 12d of the multilayer body 12 and extends from the fourth surface 12d so as to partially cover the first surface 12a, the second surface 12b, the fifth surface 12e, and the sixth surface 12f.

The first base electrode layer 32a may be disposed only at the third surface 12c of the multilayer body 12, and the second base electrode layer 32b may be disposed only at the fourth surface 12d of the multilayer body 12.

The base electrode layer 32 includes a baked layer. The following description relates to the configuration of the aforementioned baked layer of the base electrode layer 32.

The baked layer includes a glass component and a metal component. The glass component of the baked layer includes at least one selected from B, Si, Ba, Mg, Al, Li, and the like. The metal component of the baked layer includes Cu and Ag. In this case, the metal component used may be, for example, Ag-coated Cu powder. The baked layer may be multiple layers. The baked layer is baked after applying a conductive paste including the glass component and the metal component onto the multilayer body 12. The baked layer may be obtained by simultaneously firing a multilayer chip, having the inner electrode layers 16 and the dielectric layers 14, and the conductive paste applied to the multilayer chip, or may be obtained by firing the multilayer chip having the inner electrode layers 16 and the dielectric layers 14 to obtain a multilayer body, and subsequently baking the conductive paste onto the multilayer body.

If the first base electrode layer 32a includes a baked layer, a central portion, in the stacking direction x, of the first base electrode layer 32a located at the third surface 12c preferably has a thickness of, for example, about 10 μm or more and about 100 μm or less.

If the second base electrode layer 32b includes a baked layer, a central portion, in the stacking direction x, of the second base electrode layer 32b located at the fourth surface 12d preferably has a thickness of, for example, about 10 μm or more and about 1000 μm or less.

If the base electrode layer 32 formed of a baked layer is provided on the first surface 12a and the second surface 12b, a central portion, in the first direction y, of the first base electrode layer 32a located on the first surface 12a and the second surface 12b preferably has a thickness, in a direction connecting the first surface 12a and the second surface 12b, of, for example, about 7 μm or more and about 50 μm or less, and a central portion, in the first direction y, of the second base electrode layer 32b located on the first surface 12a and the second surface 12b preferably has a thickness, in the direction connecting the first surface 12a and the second surface 12b, of, for example, about 7 μm or more and about 50 μm or less.

Furthermore, if the base electrode layer 32 formed of a baked layer is provided on the fifth surface 12e and the sixth surface 12f, a central portion, in the first direction y, of the first base electrode layer 32a located on the fifth surface 12e and the sixth surface 12f preferably has a thickness, in a direction connecting the fifth surface 12e and the sixth surface 12f, of, for example, about 7 μm or more and about 50 μm or less, and a central portion, in the first direction y, of the second base electrode layer 32b located on the fifth surface 12e and the sixth surface 12f preferably has a thickness, in the direction connecting the fifth surface 12e and the sixth surface 12f, of, for example, about 7 μm or more and about 50 μm or less.

As illustrated in FIG. 2, a first glass layer 40a is disposed at an interface between the first base electrode layer 32a and the third surface 12c of the multilayer body 12. Thus, the first base electrode layer 32a including Cu covers the first glass layer 40a and a portion of an Ag segregation section 50. The Ag segregation section 50 covers a portion of a connection region where each first inner electrode layer 16a exposed from the third surface 12c of the multilayer body 12 connects to the corresponding first exposed section 28a. In this case, the first glass layer 40a covers a portion of the Ag segregation section 50. The Ag segregation section 50 is where Ag particles are segregated.

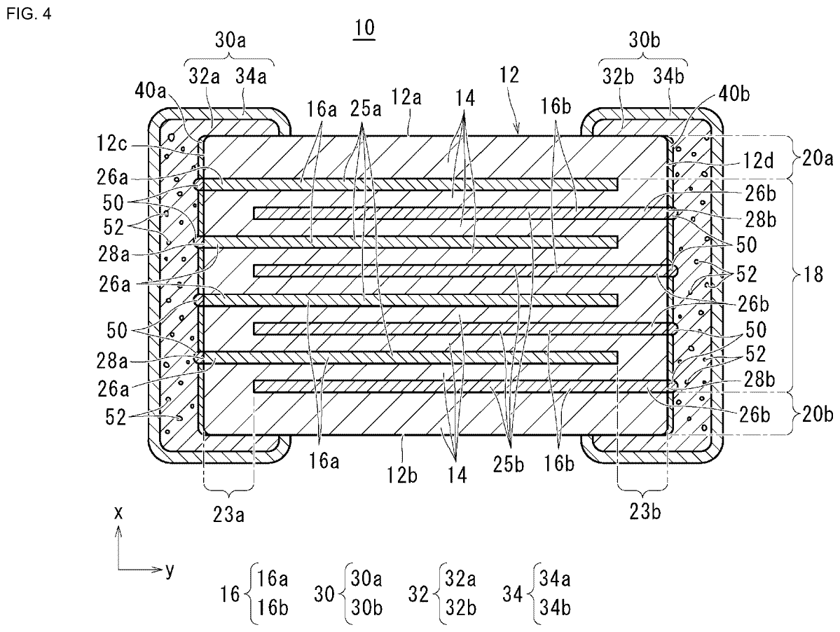

As illustrated in FIG. 4, the first base electrode layer 32a may be disposed to directly cover the Ag segregation section 50. Thus, in this case, the first glass layer 40a does not cover at least a portion of the Ag segregation section 50.

Similarly, a second glass layer 40b is disposed at an interface between the second base electrode layer 32b and the fourth surface 12d of the multilayer body 12. Thus, the second base electrode layer 32b including Cu covers the second glass layer 40b and a portion of the Ag segregation section 50. The Ag segregation section 50 covers a portion of a connection region where each first inner electrode layer 16a exposed from the fourth surface 12d of the multilayer body 12 connects to the corresponding second exposed section 28b. In this case, the second glass layer 40b covers a portion of the Ag segregation section 50. The Ag segregation section 50 is where Ag particles are segregated.

As illustrated in FIG. 4, the second base electrode layer 32b may be disposed to directly cover the Ag segregation section 50. Thus, in this case, the second glass layer 40b does not cover at least a portion of the Ag segregation section 50.

The thickness of the Ag segregation section 50 in the first direction y is preferably about 1 μm or less, for example.

The Ag concentration within an approximately 5 μm region from the third surface 12c toward the first base electrode layer 32a is preferably greater than the Ag concentration outside the approximately 5 μm region from the third surface 12c toward the first base electrode layer 32a.

The Ag concentration within an approximately 5 μm region from the fourth surface 12d toward the second base electrode layer 32b is preferably greater than the Ag concentration outside the approximately 5 μm region from the fourth surface 12d toward the second base electrode layer 32b.

The Ag particles are preferably distributed in a dot configuration outside the approximately 5 μm region from the third surface 12c toward the first base electrode layer 32a. Moreover, the Ag particles are preferably distributed in a dot configuration outside the approximately 5 μm region from the fourth surface 12d toward the second base electrode layer 32b.

The presence of Ag particles distributed in a dot configuration within the Ag segregation section 50 and the base electrode layer 32 can be checked in the following manner.

Polishing is performed to the center in the second direction z so as to expose an LT cross section (i.e., a cross section taken in the stacking direction x and the first direction y), and elemental analysis is performed on the exposed LT cross section by EDX (energy dispersive X-ray spectroscopy). Ni, Cu, and Ag are used as mapping elements. The mapping range is set to a region including 10 to 15 inner electrode layers 16 at an interface of the multilayer body 12 near the center in the stacking direction x. At an interface position of the multilayer body 12 within an observation field, a section where the Ag intensity is greater than 0 is set as the Ag segregation section 50. A section where the Cu intensity is 700 or greater is set as the base electrode layer 32, and the interface position of the multilayer body 12 is set as a boundary portion where the Cu intensity falls below 700, for example.

The plating layer 34 includes the first plating layer 34a and the second plating layer 34b.

The first plating layer 34a covers the surface of the first base electrode layer 32a.

The second plating layer 34b covers the surface of the second base electrode layer 32b.

The plating layer 34 includes, for example, at least one metal selected from Cu, Ni, Sn, Ag, Pd, an Ag—Pd alloy, or Au, or the like.

The plating layer 34 may be a single layer, or may be multiple layers. If multiple layers, for example, the plating layer 34 preferably has a two-layer structure including Ni plating and Sn plating. Since the layer that is directly in contact with the base electrode layer is a plating layer formed of Ni plating, especially if the base electrode layer is a conductive resin layer, the base electrode layer can be prevented from being eroded by solder used for mounting during mounting of the multilayer ceramic capacitor.

Furthermore, since the upper layer of the plating layer formed of Ni plating is a plating layer formed of Sn plating, wettability of solder used for mounting is improved during mounting of the two-terminal multilayer ceramic capacitor 10 onto a mounting substrate to facilitate mounting.

The thickness of the plating layer 34 per layer is preferably about 1.0 μm or more and about 6.0 μm or less, for example.

A dimension of the two-terminal multilayer ceramic capacitor 10 in the first direction y will be defined as an L dimension. The L dimension is preferably about 0.237 mm or more and about 3.80 mm or less, for example. A range between about 0.10 mm or more and about 3.80 mm or less is also possible, for example.

A dimension of the two-terminal multilayer ceramic capacitor 10 in the stacking direction x will be defined as a T dimension. The T dimension is preferably about 0.125 mm or more and about 2.80 mm or less, for example. A range between about 0.05 mm or more and about 2.80 mm or less is also possible, for example.

A dimension of the two-terminal multilayer ceramic capacitor 10 in the second direction z will be defined as a W dimension. The W dimension is preferably about 0.125 mm or more and about 2.80 mm or less, for example. A range between about 0.05 mm or more and about 2.80 mm or less is also possible, for example.

In the two-terminal multilayer ceramic capacitor 10 illustrated in FIG. 1, the Ag segregation section 50 in which Ag is segregated is disposed at a connection region between the base electrode layer 32 and each inner electrode layer 16, whereby contact points between the base electrode layer 32 and the inner electrode layer 16, which are complete solid solutions, are reduced to reduce or prevent mutual diffusion, while contact reliability between the base electrode layer 32 and the inner electrode layer 16 via the Ag segregation section 50 is ensured. Accordingly, expansion of the inner electrode layer 16 can be reduced or prevented to reduce or prevent cracks inside the multilayer body 12 and also reduce or prevent hydrogen-induced deterioration of insulation resistance.

Next, a non-limiting example of a method for manufacturing a two-terminal multilayer ceramic capacitor will be described.

First, a dielectric-layer dielectric sheet and an inner-electrode-layer conductive paste are prepared. The dielectric sheet and the inner-electrode-layer conductive paste each include a binder and a solvent. The binder and the solvent may be of known types.

The inner-electrode-layer conductive paste is printed in a predetermined pattern onto the dielectric sheet by, for example, screen printing or gravure printing. Accordingly, a dielectric sheet including a first-inner-electrode-layer pattern and a dielectric sheet including a second-inner-electrode-layer pattern are prepared.

More specifically, a gravure plate for printing the first inner electrode layers and the second inner electrode layers is prepared, and patterns of the respective inner electrode layers can be printed by using a gravure printer.

With regard to the dielectric sheets, an outer-layer dielectric sheet not having the inner-electrode-layer patterns printed thereon is also prepared.

Then, a predetermined number of dielectric sheets not having the inner-electrode-layer patterns printed thereon are stacked, whereby a portion that is to become the second outer layer section 20b at the second surface 12b side is formed. Subsequently, a portion that is to become the capacitance-generating section 18 formed as a result of the aforementioned process is stacked onto the portion that is to become the second outer layer section 20b. Then, the predetermined number of dielectric sheets not having the inner-electrode-layer patterns printed thereon are stacked onto the portion that is to become the capacitance-generating section 18 formed as a result of the aforementioned process, whereby a portion that is to become the first outer layer section 20a at the first surface 12a side is formed. Accordingly, a multilayer sheet is fabricated.

Subsequently, the multilayer sheet is pressed in the stacking direction by using a method such as isostatic pressing, whereby a multilayer block is fabricated.

Then, the multilayer block is cut to a predetermined size, whereby a multilayer chip is obtained. In this case, the corners and the edges of the multilayer chip may be rounded by barrel polishing or the like.

Subsequently, the obtained multilayer chip is fired, whereby the multilayer body 12 is fabricated. The firing temperature depends on the materials of the dielectric layers 14 and the inner electrode layers 16, but preferably ranges between about 900° C. or higher and about 1400° C. or lower, for example.

In the following description, each base electrode layer includes a baked layer. When a baked layer is to be formed, a conductive paste including a glass component and metal is prepared, applied, and subsequently baked, whereby a base electrode layer is formed. The conductive paste used includes Ag-coated Cu powder as a metal component.

The first base electrode layer 32a of the first outer electrode 30a and the second base electrode layer 32b of the second outer electrode 30b are formed onto the third surface 12c and the fourth surface 12d of the multilayer body 12 obtained as a result of firing.

When a baked layer is to be formed as the base electrode layer 32, the conductive paste including the glass component and the metal component is applied by a method such as dipping. In this case, a conductive paste including Cu powder having a relatively thick Ag coating is applied and baked, and subsequently, a conductive paste including Cu powder having a relatively thin Ag coating is applied thereon and baked, whereby the base electrode layer 32 is formed. Accordingly, the Ag concentration in the base electrode layer 32 in a region near an end surface of the multilayer body 12 can be increased. In this case, the temperature in the baking process preferably ranges between about 700° C. or higher and about 850° C. or lower, for example. If the temperature in the baking process is too high, mutual diffusion between Ni and Cu is promoted, thus making it difficult for the Ag segregation section 50 to be formed at the connection region between the inner electrode layer and the baked layer. By setting the temperature in the baking process to be low within a range that can ensure denseness of the base electrode layer 32 and connectivity between the base electrode layer 32 and the inner electrode layers 16, Ag is more likely to segregate at the connection region between the base electrode layer 32 and the inner electrode layers 16.

Finally, the plating layer 34 is formed. The plating layer 34 may be formed at the surface of the base electrode layer 32, or may be formed directly on the multilayer body 12. In this example embodiment, the plating layer 34 is formed at the surface of the base electrode layer 32. More specifically, an Ni plating layer as a lower plating layer and an Sn plating layer as an upper plating layer are formed on the base electrode layer 32. When performing the plating process, either electrolytic plating or electroless plating may be used. However, electroless plating requires pretreatment using a catalyst or the like to improve the plating deposition rate, and is thus disadvantageous in terms of complicating the process. Therefore, it is normally preferable to use electrolytic plating.

The two-terminal multilayer ceramic capacitor 10 according to the first example embodiment is manufactured in the above-described manner.

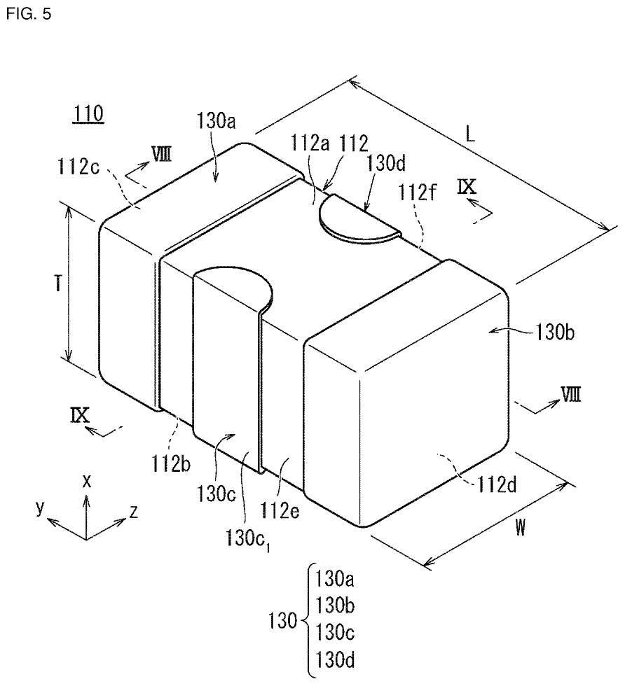

A three-terminal multilayer ceramic capacitor 110 will now be described as a multilayer ceramic capacitor according to a second example embodiment of the present invention with reference to FIG. 5 to FIG. 9.

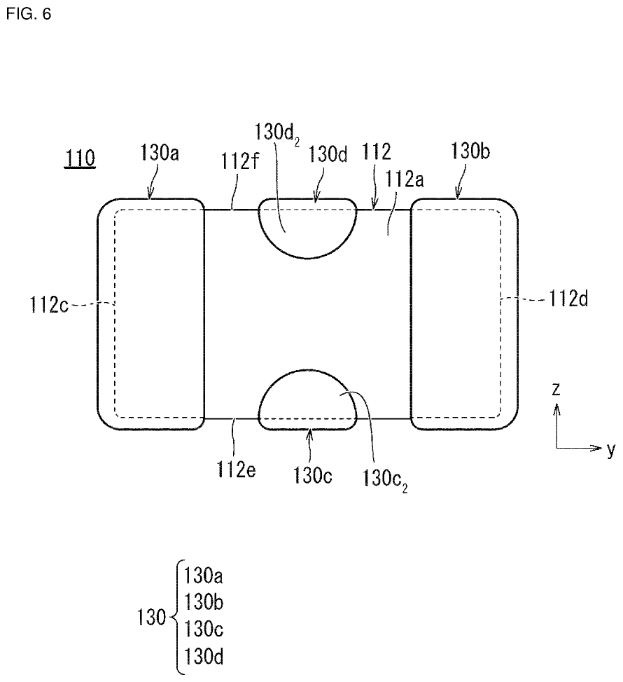

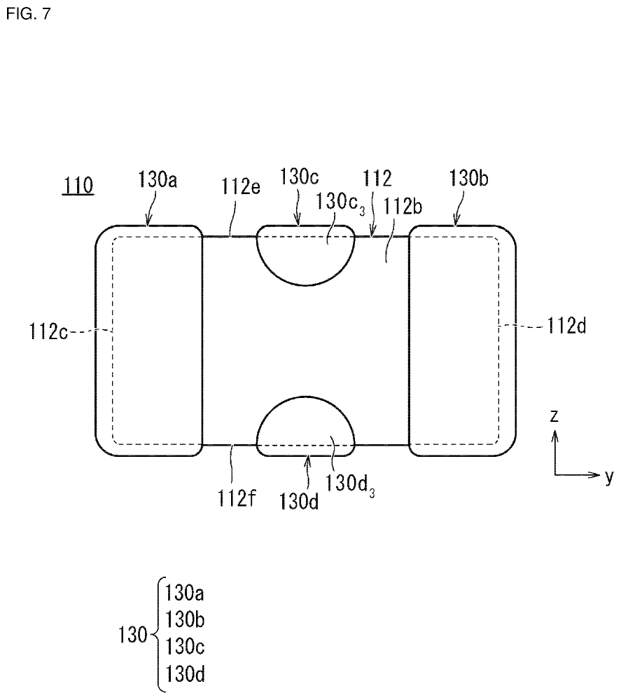

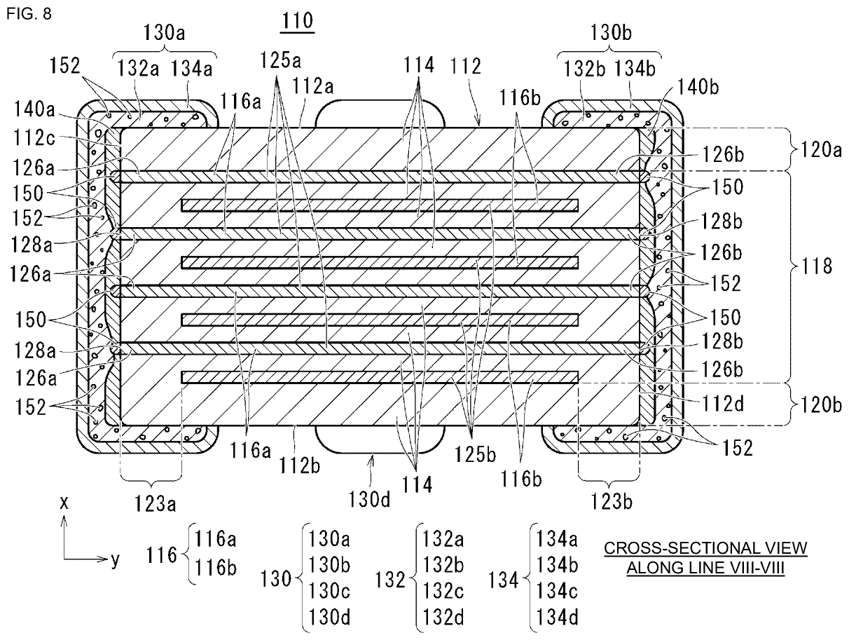

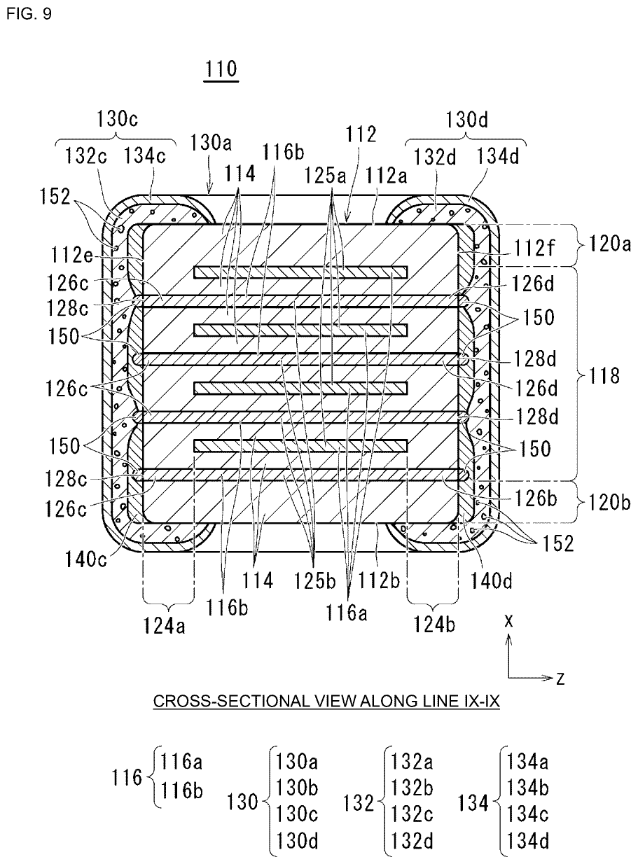

FIG. 5 is an external perspective view illustrating an example of the three-terminal multilayer ceramic capacitor according to the second example embodiment of the present invention. FIG. 6 is a top view illustrating the example of the three-terminal multilayer ceramic capacitor according to the second example embodiment of the present invention. FIG. 7 is a bottom view illustrating the example of the three-terminal multilayer ceramic capacitor according to the second example embodiment of the present invention. FIG. 8 is a cross-sectional view taken along line VIII-VIII in FIG. 5. FIG. 9 is a cross-sectional view taken along line IX-IX in FIG. 5.

As illustrated in FIG. 5 to FIG. 9, the three-terminal multilayer ceramic capacitor 110 includes, for example, a multilayer body 112 and an outer electrode 130.

The multilayer body 112 includes multiple stacked dielectric layers 114 and multiple inner electrode layers 116 stacked on the dielectric layers 114. The inner electrode layers 116 have first inner electrode layers 116a and second inner electrode layers 116b. The first inner electrode layers 116a and the second inner electrode layers 116b will be described in detail later.

The multilayer body 112 includes a first surface 112a and a second surface 112b that are opposed to each other in the stacking direction x, a third surface 112c and a fourth surface 112d that are opposed to each other in the first direction y orthogonal to the stacking direction x, and a fifth surface 112e and a sixth surface 112f that are opposed to each other in the second direction z orthogonal to the stacking direction x and the first direction y.

The multilayer body 112 has a rectangular parallelepiped shape, and the multilayer body 112 preferably has rounded corners and edges. The corners are where three surfaces of the multilayer body 112 intersect, and the edges are where two surfaces of the multilayer body 112 intersect. The first surface 112a and the second surface 112b, the third surface 112c and the fourth surface 112d, and the fifth surface 112e and the sixth surface 112f may be partially or entirely provided with protrusions, recesses, and/or the like.

The multilayer body 112 includes a capacitance-generating section 118, a first outer layer section 120a located at the first surface 112a side, and a second outer layer section 120b located at the second surface 112b side. The first outer layer section 120a and the second outer layer section 120b are disposed to sandwich the capacitance-generating section 118 therebetween in the stacking direction x.

In the capacitance-generating section 118, the first inner electrode layers 116a and the second inner electrode layers 116b are alternately stacked with the dielectric layers 114 interposed therebetween.

The first outer layer section 120a is located at the first surface 112a side of the multilayer body 112, and is an aggregate of multiple dielectric layers 114 located between the first surface 112a and the capacitance-generating section 118 closest to the first surface 112a. The second outer layer section 120b is located at the second surface 112b side of the multilayer body 112, and is an aggregate of multiple dielectric layers 114 located between the second surface 112b and the capacitance-generating section 118 closest to the second surface 112b. Furthermore, a region interposed between the first outer layer section 120a and the second outer layer section 120b is the capacitance-generating section 118.

As illustrated in FIG. 8, the multilayer body 112 includes end portions (L-gaps) 123a and 123b of the multilayer body 112, which are located between the capacitance-generating section 118 and the third surface 112c and between the capacitance-generating section 118 and the fourth surface 112d.

As illustrated in FIG. 9, the multilayer body 112 includes side portions (W-gaps) 124a and 124b of the multilayer body 112, which are located between the capacitance-generating section 118 and the fifth surface 112e and between the capacitance-generating section 118 and the sixth surface 112f.

Since the material of the dielectric layers 114 is identical to that of the dielectric layers 14 in the two-terminal multilayer ceramic capacitor 10, a description thereof will be omitted.

Furthermore, since the average thickness of the dielectric layers 114 in the stacking direction x after firing is also identical to that of the dielectric layers 14 in the two-terminal multilayer ceramic capacitor 10, a description thereof will be omitted.

The multilayer body 112 includes the multiple first inner electrode layers 116a and the multiple second inner electrode layers 116b as the multiple inner electrode layers 116. The multiple first inner electrode layers 116a and the multiple second inner electrode layers 116b are substantially parallel to the first surface 112a and the second surface 112b, and are embedded so as to be alternately arranged in the stacking direction x of the multilayer body 112 with the dielectric layers 114 interposed therebetween.

The first inner electrode layers 116a are disposed on the multiple dielectric layers 114. The first inner electrode layers 116a extend to the third surface 112c and the fourth surface 112d.

More specifically, the first inner electrode layers 116a extend between the third surface 112c and the fourth surface 112d of the multilayer body 112, and have first counter electrode sections 125a at the central portion thereof, first extraction electrode sections 126a extending from the first counter electrode sections 125a to the third surface 112c of the multilayer body 112, and second extraction electrode sections 126b extending from the first counter electrode sections 125a to the fourth surface 112d of the multilayer body 112. Each first counter electrode section 125a is located on the central portion of the corresponding dielectric layer 114. Each of the first extraction electrode sections 126a includes a first exposed section 128a exposed at the third surface 112c of the multilayer body 112, and each of the second extraction electrode sections 126b includes a second exposed section 128b exposed at the fourth surface 112d of the multilayer body 112. Thus, the first inner electrode layers 116a are not exposed at the fifth surface 112e or the sixth surface 112f of the multilayer body 112.

The shape of the first inner electrode layers 116a is not particularly limited, but is preferably rectangular in plan view. The shape of the first counter electrode sections 125a, the first extraction electrode sections 126a, and the second extraction electrode sections 126b of the first inner electrode layers 116a is not particularly limited, but is preferably rectangular in plan view. However, the corners may be rounded.

The second inner electrode layers 116b are disposed on multiple dielectric layers 114. The second inner electrode layers 116b extend to the fifth surface 112e and the sixth surface 112f. The second inner electrode layers 116b are disposed on the dielectric layers 114 different from the dielectric layers 114 where the first inner electrode layers 116a are disposed.

More specifically, the second inner electrode layers 116b extend between the fifth surface 112e and the sixth surface 112f of the multilayer body 112, and include second counter electrode sections 125b at the central portion thereof, first extension sections 126c extending from the second counter electrode sections 125b to the fifth surface 112e, and second extension sections 126d extending from the second counter electrode sections 125b to the sixth surface 112f. The second counter electrode sections 125b extend in the direction of the third surface 112c and have a rectangular shape extending in the direction of the fourth surface 112d. Each second counter electrode section 125b is located on the central portion of the corresponding dielectric layer 114. Each of the first extension sections 126c includes a third exposed section 128c exposed at the fifth surface 112e of the multilayer body 112, and each of the second extension sections 126d has a fourth exposed section 128d exposed at the sixth surface 112f of the multilayer body 112. Thus, the second inner electrode layers 116b are not exposed at the third surface 112c or the fourth surface 112d of the multilayer body 112.

The shape of the second counter electrode sections 125b, the first extension sections 126c, and the second extension sections 126d of the second inner electrode layers 116b is not particularly limited, but is preferably rectangular in plan view. However, the corners may be rounded.

The first counter electrode sections 125a of the first inner electrode layers 116a and the second counter electrode sections 125b of the second inner electrode layers 116b face each other. In this example embodiment, the first counter electrode sections 125a of the first inner electrode layers 116a and the second counter electrode sections 125b of the second inner electrode layers 116b face each other via the dielectric layers 114 such that electrostatic capacitance is generated and capacitor characteristics are exhibited.

The material composition of the first inner electrode layers 116a and the second inner electrode layers 116b, as well as the in-layer composition in the stacking direction x, are similar to those of the first inner electrode layers 16a and the second inner electrode layers 16b of the two-terminal multilayer ceramic capacitor 10 according to the first example embodiment.

The thickness of each first inner electrode layer 116a is not particularly limited, but is preferably, for example, about 0.4 μm or more and about 1.0 μm or less.

The thickness of each second inner electrode layer 116b is not particularly limited, but is preferably, for example, about 0.4 μm or more and about 1.0 μm or less.

The total number of first inner electrode layers 116a and second inner electrode layers 116b is preferably 50 or more and 1500 or less, for example.

The number of first inner electrode layers 116a is not particularly limited, but is preferably, for example, 25 or more and 750 or less, for example.

The number of second inner electrode layers 116b is not particularly limited, but is preferably, for example, 25 or more and 750 or less, for example.

The outer electrode 130 is disposed at the third surface 112c side and the fourth surface 112d side of the multilayer body 112, as well as at the fifth surface 112e side and the sixth surface 112f side. The outer electrode 130 includes a first outer electrode 130a, a second outer electrode 130b, a third outer electrode 130c, and a fourth outer electrode 130d.

The first outer electrode 130a is connected to the first inner electrode layers 116a and is disposed on the third surface 112c. The first outer electrode 130a may also be disposed at a portion of the first surface 112a, a portion of the second surface 112b, a portion of the fifth surface 112e, and a portion of the sixth surface 112f.

The second outer electrode 130b is connected to the first inner electrode layers 116a and is disposed on the fourth surface 112d. The second outer electrode 130b may also be disposed at a portion of the first surface 112a, a portion of the second surface 112b, a portion of the fifth surface 112e, and a portion of the sixth surface 112f.

The third outer electrode 130c is connected to the second inner electrode layers 116b and is disposed on the fifth surface 112e. The third outer electrode 130c may include a first covering section 130c₁ exposed at the fifth surface 112e and covering the second inner electrode layers 116b, a first folded-back section 130c₂ parallel to the second inner electrode layers 116b on the first surface 112a, and a second folded-back section 130c₃ parallel to the second inner electrode layers 116b on the second surface 112b. With the second folded-back section 130c₃ provided, the reliability of electrical connection with a mounting substrate can be further maintained.

The fourth outer electrode 130d is connected to the second inner electrode layers 116b and is disposed on the sixth surface 112f. The fourth outer electrode 130d may include a second covering section 130d₁ (not illustrated) exposed at the sixth surface 112f and covering the second inner electrode layers 116b, a third folded-back section 130d₂ parallel to the second inner electrode layers 116b on the first surface 112a, and a fourth folded-back section 130d₃ parallel to the second inner electrode layers 116b on the second surface 112b. With the fourth folded-back section 130d₃ provided, the reliability of electrical connection with a mounting substrate can be further maintained.

The outer electrode 130 includes a base electrode layer 132 disposed at the surface of the multilayer body 112, and a plating layer 134 covering the base electrode layer 132.

The base electrode layer 132 includes a first base electrode layer 132a, a second base electrode layer 132b, a third base electrode layer 132c, and a fourth base electrode layer 132d.

The plating layer 134 includes a first plating layer 134a, a second plating layer 134b, a third plating layer 134c, and a fourth plating layer 134d.

In other words, the first outer electrode 130a includes the first base electrode layer 132a and the first plating layer 134a. The second outer electrode 130b includes the second base electrode layer 132b and the second plating layer 134b. The third outer electrode 130c includes the third base electrode layer 132c and the third plating layer 134c. The fourth outer electrode 130d includes the fourth base electrode layer 132d and the fourth plating layer 134d.

The first base electrode layer 132a is disposed at the third surface 112c of the multilayer body 112, and extends from the third surface 112c so as to partially cover the first surface 112a, the second surface 112b, the fifth surface 112e, and the sixth surface 112f.

The second base electrode layer 132b is disposed at the fourth surface 112d of the multilayer body 112, and extends from the fourth surface 112d so as to partially cover the first surface 112a, the second surface 112b, the fifth surface 112e, and the sixth surface 112f.

The first base electrode layer 132a may be disposed only at the third surface 112c of the multilayer body 112, and the second base electrode layer 132b may be disposed only at the fourth surface 112d of the multilayer body 112.

The third base electrode layer 132c is disposed at the fifth surface 112e of the multilayer body 112, and extends from the fifth surface 112e so as to partially cover the first surface 112a and the second surface 112b.

The fourth base electrode layer 132d is disposed at the sixth surface 112f of the multilayer body 112, and extends from the sixth surface 112f so as to partially cover the first surface 112a and the second surface 112b.

The base electrode layer 132 includes a baked layer. The following description relates to the configuration of the aforementioned baked layer of the base electrode layer 132.

The baked layer includes a glass component and a metal component. The glass component of the baked layer includes at least one selected from B, Si, Ba, Mg, Al, or Li, or the like. The metal component of the baked layer includes, for example, Cu and Ag. In this case, the metal component used may be, for example, Ag-coated Cu powder. The baked layer may be multiple layers. The baked layer is baked after applying a conductive paste including the glass component and the metal component onto the multilayer body 112. The baked layer may be obtained by simultaneously firing a multilayer chip, having the inner electrode layers 116 and the dielectric layers 114, and the conductive paste applied to the multilayer chip, or may be obtained by firing the multilayer chip having the inner electrode layers 116 and the dielectric layers 114 to obtain the multilayer body 112, and subsequently applying and baking the conductive paste onto the multilayer body 112.

A central portion, in the stacking direction x, of the first base electrode layer 132a located at the third surface 112c preferably has a thickness, in the first direction y connecting the third surface 112c and the fourth surface 112d, of about 10 μm or more and about 100 μm or less, for example.

A central portion, in the stacking direction x, of the second base electrode layer 132b located at the fourth surface 112d preferably has a thickness, in the first direction connecting the third surface 112c and the fourth surface 112d, of about 10 μm or more and about 100 μm or less, for example.

If the first base electrode layer 132a is provided on a portion of the first surface 112a, a portion of the second surface 112b, a portion of the fifth surface 112e, and a portion of the sixth surface 112f, a central portion, in the first direction y connecting the third surface 112c and the fourth surface 112d, of the first base electrode layer 132a located on the first surface 112a and the second surface 112b preferably has a thickness, in the stacking direction x connecting the first surface 112a and the second surface 112b, of, for example, about 7 μm or more and about 50 μm or less. Furthermore, a central portion, in the first direction y connecting the third surface 112c and the fourth surface 112d, of the first base electrode layer 132a located on the fifth surface 112e and the sixth surface 112f preferably has a thickness, in the second direction z connecting the fifth surface 112e and the sixth surface 112f, of, for example, about 7 μm or more and about 50 μm or less.

If the second base electrode layer 132b is provided on a portion of the first surface 112a, a portion of the second surface 112b, a portion of the fifth surface 112e, and a portion of the sixth surface 112f, a central portion, in the first direction y connecting the third surface 112c and the fourth surface 112d, of the second base electrode layer 132b located on the first surface 112a and the second surface 112b preferably has a thickness, in the stacking direction x connecting the first surface 112a and the second surface 112b, of, for example, about 7 μm or more and about 50 μm or less. Furthermore, a central portion, in the first direction y connecting the third surface 112c and the fourth surface 112d, of the second base electrode layer 132b located on the fifth surface 112e and the sixth surface 112f preferably has a thickness, in the second direction z connecting the fifth surface 112e and the sixth surface 112f, of, for example, about 7 μm or more and about 50 μm or less.

A central portion, in the first direction y connecting the third surface 112c and the fourth surface 112d, of the third base electrode layer 132c located at the fifth surface 112e preferably has a thickness, in the second direction z connecting the fifth surface 112e and the sixth surface 112f, of about 10 μm or more and about 100 μm or less, for example.

A central portion, in the first direction y connecting the third surface 112c and the fourth surface 112d, of the fourth base electrode layer 132d located at the sixth surface 112f preferably has a thickness, in the second direction z connecting the fifth surface 112e and the sixth surface 112f, of about 10 μm or more and about 100 μm or less, for example.

A central portion, in the first direction y connecting the third surface 112c and the fourth surface 112d, of the third base electrode layer 132c located on the first surface 112a and the second surface 112b preferably has a thickness, in the stacking direction x connecting the first surface 112a and the second surface 112b, of, for example, about 7 μm or more and about 50 μm or less.

A central portion, in the first direction y connecting the third surface 112c and the fourth surface 112d, of the fourth base electrode layer 132d located on the first surface 112a and the second surface 112b preferably has a thickness, in the stacking direction x connecting the first surface 112a and the second surface 112b, of, for example, about 7 μm or more and about 50 μm or less.

As illustrated in FIG. 8, a first glass layer 140a is disposed at an interface between the first base electrode layer 132a and the third surface 112c of the multilayer body 112. Thus, the first base electrode layer 132a including Cu covers the first glass layer 140a and a portion of an Ag segregation section 150. The Ag segregation section 150 covers a portion of a connection region where each first inner electrode layer 116a exposed from the third surface 112c of the multilayer body 112 connects to the corresponding first exposed section 128a. In this case, the first glass layer 140a covers the Ag segregation section 150. The Ag segregation section 150 is where Ag particles are segregated. The first base electrode layer 132a may be disposed to directly cover the Ag segregation section 150. Thus, in this case, the first glass layer 140a does not cover at least a portion of the Ag segregation section 150.

Similarly, as illustrated in FIG. 8, a second glass layer 140b is disposed at an interface between the second base electrode layer 132b and the fourth surface 112d of the multilayer body 112. Thus, the second base electrode layer 132b including Cu covers the second glass layer 140b and a portion of the Ag segregation section 150. The Ag segregation section 150 covers a portion of a connection region where each first inner electrode layer 116a exposed from the fourth surface 112d of the multilayer body 112 connects to the corresponding first exposed section 128a. In this case, the second glass layer 140b covers the Ag segregation section 150. The Ag segregation section 150 is where Ag particles are segregated. The second base electrode layer 132b may be disposed to directly cover the Ag segregation section 150. Thus, in this case, the second glass layer 140b does not cover at least a portion of the Ag segregation section 150.

The thickness of the Ag segregation section 150 in the first direction y is preferably about 1 μm or less, for example.

The Ag concentration within an approximately 5 μm region from the third surface 112c toward the first base electrode layer 132a is preferably greater than the Ag concentration outside the approximately 5 μm region from the third surface 112c toward the first base electrode layer 132a.

The Ag concentration within an approximately 5 μm region from the fourth surface 112d toward the second base electrode layer 132b is preferably greater than the Ag concentration outside the approximately 5 μm region from the fourth surface 112d toward the second base electrode layer 132b.

The Ag particles are preferably distributed in a dot configuration outside the approximately 5 μm region from the third surface 112c toward the first base electrode layer 132a. Moreover, the Ag particles are preferably distributed in a dot configuration outside the approximately 5 μm region from the fourth surface 112d toward the second base electrode layer 132b.

As illustrated in FIG. 9, a third glass layer 140c is disposed at an interface between the third base electrode layer 132c and the fifth surface 112e of the multilayer body 112. Thus, the third base electrode layer 132c including Cu covers the third glass layer 140c and a portion of the Ag segregation section 150. The Ag segregation section 150 covers a portion of a connection region where each first inner electrode layer 116a exposed from the fifth surface 112e of the multilayer body 112 connects to the corresponding third exposed section 128c. In this case, the third glass layer 140c covers the Ag segregation section 150. The Ag segregation section 150 is where Ag particles are segregated. The third base electrode layer 132c may be disposed to directly cover the Ag segregation section 150. Thus, in this case, the third glass layer 140c does not cover at least a portion of the Ag segregation section 150.

Similarly, as illustrated in FIG. 9, a fourth glass layer 140d is disposed at an interface between the fourth base electrode layer 132d and the sixth surface 112f of the multilayer body 112. Thus, the fourth base electrode layer 132d including Cu covers the fourth glass layer 140d and a portion of the Ag segregation section 150. The Ag segregation section 150 covers a portion of connection region where each first inner electrode layer 116a exposed from the sixth surface 112f of the multilayer body 112 connects to the corresponding fourth exposed section 128d. In this case, the fourth glass layer 140d covers the Ag segregation section 150. The Ag segregation section 150 is where Ag particles are segregated. The fourth base electrode layer 132d may be disposed to directly cover the Ag segregation section 150. Thus, in this case, the fourth glass layer 140d does not cover at least a portion of the Ag segregation section 150.

The thickness of the Ag segregation section 150 in the first direction y is preferably about 1 μm or less, for example.

The Ag concentration within an approximately 5 μm region from the fifth surface 112e toward the third base electrode layer 132c is preferably greater than the Ag concentration outside the approximately 5 μm region from the fifth surface 112e toward the third base electrode layer 132c.

The Ag concentration within an approximately 5 μm region from the sixth surface 112f toward the fourth base electrode layer 132d is preferably greater than the Ag concentration outside the approximately 5 μm region from the sixth surface 112f toward the fourth base electrode layer 132d.

The Ag particles are preferably distributed in a dot configuration outside the approximately 5 μm region from the fifth surface 112e toward the third base electrode layer 132c. The Ag particles are preferably distributed in a dot configuration outside the approximately 5 μm region from the sixth surface 112f toward the fourth base electrode layer 132d.

Although not illustrated, the first base electrode layer 132a may be disposed to directly cover the Ag segregation section 150, the second base electrode layer 132b may be disposed to directly cover the Ag segregation section 150, the third base electrode layer 132c may be disposed to directly cover the Ag segregation section 150, and the fourth base electrode layer 132d may be disposed to directly cover the Ag segregation section 150. Thus, in this case, each of the first glass layer 140a to the fourth glass layer 140d does not cover at least a portion of the Ag segregation section 150.

The plating layer 134 includes the first plating layer 134a, the second plating layer 134b, the third plating layer 134c, and the fourth plating layer 134d.

The first plating layer 134a covers the surface of the first base electrode layer 132a.

The second plating layer 134b covers the surface of the second base electrode layer 132b.

The third plating layer 134c covers the surface of the third base electrode layer 132c.

The fourth plating layer 134d covers the surface of the fourth base electrode layer 132d.

The plating layer 134 includes, for example, at least one metal selected from Cu, Ni, Sn, Ag, Pd, an Ag—Pd alloy, or Au, or the like.

The plating layer 134 may be a single layer, or may be multiple layers. If multiple layers, for example, the plating layer 134 preferably has a two-layer structure including Ni plating and Sn plating. Since the layer that is directly in contact with the base electrode layer is a plating layer formed of Ni plating, especially if the base electrode layer is a conductive resin layer, the base electrode layer can be prevented from being eroded by solder used for mounting during mounting of the multilayer ceramic capacitor.

Furthermore, since the upper layer of the plating layer formed of Ni plating is a plating layer formed of Sn plating, wettability of solder used for mounting is improved during mounting of the three-terminal multilayer ceramic capacitor 110 onto a mounting substrate to facilitate mounting.

The thickness of the plating layer 134 per layer is preferably about 1.0 μm or more and about 6.0 μm or less, for example.

A dimension of the three-terminal multilayer ceramic capacitor 110 in the first direction y will be defined as an L dimension. The L dimension is preferably about 0.237 mm or more and about 3.80 mm or less, for example. A range between about 0.10 mm or more and about 3.80 mm or less is also possible, for example.

A dimension of the three-terminal multilayer ceramic capacitor 110 in the stacking direction x will be defined as a T dimension. The T dimension is preferably about 0.125 mm or more and about 2.80 mm or less, for example. A range between about 0.05 mm or more and about 2.80 mm or less is also possible, for example.

A dimension of the three-terminal multilayer ceramic capacitor 110 in the second direction z will be defined as a W dimension. The W dimension is preferably about 0.125 mm or more and about 2.80 mm or less, for example. A range between about 0.05 mm or more and about 2.80 mm or less is also possible, for example.

In the three-terminal multilayer ceramic capacitor 110 illustrated in FIG. 5, advantages similar to those of the two-terminal multilayer ceramic capacitor 10 illustrated in FIG. 1 are exhibited.

Next, a non-limiting example of a method for manufacturing a three-terminal multilayer ceramic capacitor will be described.

First, a dielectric-layer dielectric sheet and an inner-electrode-layer conductive paste are prepared. The dielectric sheet and the inner-electrode-layer conductive paste each include a binder and a solvent. The binder and the solvent may be of known types.

The inner-electrode-layer conductive paste is printed in a predetermined pattern onto the dielectric sheet by, for example, screen printing, gravure printing, or the like. Accordingly, a dielectric sheet including a first-inner-electrode-layer pattern and a dielectric sheet including a second-inner-electrode-layer pattern are prepared.

More specifically, a gravure plate for printing the first inner electrode layers and the second inner electrode layers is prepared, and patterns of the respective inner electrode layers can be printed by using a gravure printer.

With regard to the dielectric sheets, an outer-layer dielectric sheet not having the inner-electrode-layer patterns printed thereon is also prepared.

Then, a predetermined number of dielectric sheets not having the inner-electrode-layer patterns printed thereon are stacked, whereby a portion that is to become the second outer layer section 120b at the second surface 112b side is formed. Subsequently, a portion that is to become the capacitance-generating section 118 formed as a result of the aforementioned process is stacked onto the portion that is to become the second outer layer section 120b. Then, the predetermined number of dielectric sheets not having the inner-electrode-layer patterns printed thereon are stacked onto the portion that is to become the capacitance-generating section 118 formed as a result of the aforementioned process, whereby a portion that is to become the first outer layer section 120a at the first surface 112a side is formed. Accordingly, a multilayer sheet is fabricated.

Subsequently, the multilayer sheet is pressed in the stacking direction by using a method such as isostatic pressing, whereby a multilayer block is fabricated.

Then, the multilayer block is cut to a predetermined size, whereby a multilayer chip is obtained. In this case, the corners and the edges of the multilayer chip may be rounded by barrel polishing or the like.

Subsequently, the obtained multilayer chip is fired, whereby the multilayer body 112 is fabricated. The firing temperature depends on the materials of the dielectric layers 114 and the inner electrode layers 116, but preferably ranges between about 900° C. or higher and about 1400° C. or lower, for example.

In the following description, each base electrode layer includes a baked layer. When a baked layer is to be formed, a conductive paste including a glass component and metal is prepared, applied, and subsequently baked, whereby a base electrode layer is formed.

The third base electrode layer 132c of the third outer electrode 130c is formed onto the fifth surface 112e of the multilayer body 112 obtained as a result of firing, and the fourth base electrode layer 132d of the fourth outer electrode 130d is formed onto the sixth surface 112f of the multilayer body 112.

When a baked layer is to be formed as the base electrode layer 132, the conductive paste including the glass component and the metal component is applied by a method such as a method involving extruding the paste from a slit or a roller transfer method. Then, a baking process is performed, whereby a baked layer is formed as the base electrode layer 132. In this case, the temperature in the baking process preferably ranges between about 700° C. or higher and about 850° C. or lower, for example. If the temperature in the baking process is too high, mutual diffusion between Ni and Cu is promoted, thus making it difficult for the Ag segregation section 150 to be formed at the connection region between the inner electrode layer and the baked layer.

A method used for forming the baked layer may be any of various methods. For example, a method may be used in which the orientation of the multilayer body 112 is adjusted by a camera or a magnet such that the fifth surface 112e or the sixth surface 112f faces downward, the multilayer body 112 is subsequently held by a holding jig, and the conductive paste is applied by being extruded from a slit or a hole. In this method, the amount by which the conductive paste is extruded is increased so that the third base electrode layer 132c and the fourth base electrode layer 132d can be formed not only onto the fifth surface 112e and the sixth surface 112f but also onto a portion of the first surface 112a and a portion of the second surface 112b.

Then, the first base electrode layer 132a of the first outer electrode 130a is formed onto the third surface 112c of the multilayer body 112 obtained as a result of firing, and the second base electrode layer 132b of the second outer electrode 130b is formed onto the fourth surface 112d of the multilayer body 112. In this example embodiment, the first base electrode layer 132a and the second base electrode layer 132b are formed by dipping to extend not only to the third surface 112c and the fourth surface 112d but also to a portion of the first surface 112a, a portion of the second surface 112b, a portion of the fifth surface 112e, and a portion of the sixth surface 112f.

The baking process may involve simultaneously baking the first base electrode layer 132a of the first outer electrode 130a, the second base electrode layer 132b of the second outer electrode 130b, the third base electrode layer 132c of the third outer electrode 130c, and the fourth base electrode layer 132d of the fourth outer electrode 130d, or may involve separately baking the first base electrode layer 132a of the first outer electrode 130a, the second base electrode layer 132b of the second outer electrode 130b, the third base electrode layer 132c of the third outer electrode 130c, and the fourth base electrode layer 132d of the fourth outer electrode 130d.

Finally, the plating layer 134 is formed. The plating layer 134 may be formed at the surface of the base electrode layer 132, or may be formed directly on the multilayer body 112. In this example embodiment, the plating layer 134 is formed at the surface of the base electrode layer 132. More specifically, an Ni plating layer as a lower plating layer and an Sn plating layer as an upper plating layer are formed on the base electrode layer 132. When performing the plating process, either electrolytic plating or electroless plating may be used. However, electroless plating requires pretreatment using a catalyst or the like to improve the plating deposition rate, and is thus disadvantageous in terms of complicating the process. Therefore, it is normally preferable to use electrolytic plating.

The three-terminal multilayer ceramic capacitor 110 according to the second example embodiment is manufactured in the above-described manner.

Next, in order to check the advantageous effects of the aforementioned two-terminal multilayer ceramic capacitor according to an example embodiment of the present invention, quality confirmation is performed by conducting experiments related to the presence or absence of a crack, moisture-resistance reliability, and contact reliability between each inner electrode layer and the outer electrode.

By using the manufacturing methods according to the above example embodiments, multilayer ceramic capacitors are fabricated as samples according to Comparative Example 1 to Comparative Example 6 and Example 1 to Example 4.
Structure of Multilayer Ceramic Capacitor: Multilayer Ceramic Capacitor Illustrated in FIG. 1
Dimension of Multilayer Ceramic Capacitor in First Direction: 0.650 mm
Dimension of Multilayer Ceramic Capacitor in Second Direction: 1.150 mm
Dimension of Multilayer Ceramic Capacitor in Stacking Direction: 0.200 mm
Thickness of Dielectric Layer: 0.71 μm
Thickness of Inner Electrode Layer: 0.54 μm
Number of First Inner Electrode Layers: 53
Number of Second Inner Electrode Layers: 54
Thickness of First Outer Layer Section: 17 μm
Thickness of Second Outer Layer Section: 17 μm
Dimension of L-Gap: 72 μm
Dimension of W-Gap: 64 μm

Samples according to Examples are fabricated in accordance with the manufacturing method for the two-terminal multilayer ceramic capacitor according to the first example embodiment. Specifically, in each sample fabricated, an Ag segregation section in which Ag particles are segregated is disposed at an exposed section of an inner electrode layer. As comparative examples, samples in which the Ag particles are not segregated are fabricated. The sample according to Comparative Example 6 has an Ag segregation section, but the baking temperature for the base electrode layer is set to 900° C.

The presence or absence of a crack is checked by removing the base electrode layer using a removal solution to expose the third surface or the fourth surface of the multilayer body, and observing the multilayer body under a dark field of a metallurgical microscope at a magnification of 20× or more. A sample is determined to be defective if a crack is detected. The number of samples is set to 100. The defect rate is calculated according to the formula: (number of defective samples/100)×100. A determination result of “∘” is given when the defect rate is 0%, a determination result of “Δ” is given when the defect rate is higher than 0% and lower than or equal to 1.08, and a determination result of “×” is given when the defect rate is higher than 1.0%.

The experimental conditions for the moisture-resistance reliability are as follows.

First, each sample is mounted on a wiring board by using solder, and an insulation resistance value is measured.

The multilayer ceramic capacitor of each sample mounted on the wiring board is placed in a high-temperature high-humidity chamber and is subjected to an environment of 125° C. and a relative humidity of 95% RH. In such an environment, the multilayer ceramic capacitor according to each sample is set in a state where a direct-current voltage of 4 V is applied between the first outer electrode and the second outer electrode thereof, and this state is maintained for 144 hours. Then, the insulation resistance value of the multilayer ceramic capacitor according to each sample is measured upon completion of this insulation test. A sample is determined to be defective if the insulation resistance value after the moisture resistance test has decreased by one order of magnitude or more relative to the insulation resistance value before the moisture resistance test. The number of samples is 72. The defect rate is calculated according to the formula: (number of defective samples/72)×100. A determination result of “∘” is given when the defect rate is 0%, a determination result of “Δ” is given when the defect rate is higher than 0% and lower than or equal to 1.4%, and a determination result of “×” is given when the defect rate is higher than 1.4%.

A heat recovery process is performed while each sample is held for 60 minutes in an environment set at 150° C. Subsequently, each sample is left to stand for 24 hours, and the electrostatic capacitance is measured using a C meter.

After the electrostatic capacitance is measured, a discharge test is performed on each sample. Then, the heat recovery process is performed again while the sample is held for 60 minutes in the environment set at 150° C. After the sample is left to stand for 24 hours, the electrostatic capacitance is measured again using the C meter.

If a difference in the values of the electrostatic capacitance before and after the discharge test is greater than or equal to (electrostatic capacitance before discharge test/number of stacked layers), a sample is determined to be defective. The number of samples is set to 30. The defect rate is calculated according to the formula: (number of defective samples/30)×100. A determination result of “∘” is given when the defect rate is 0%, a determination result of “Δ” is given when the defect rate is higher than 0% and lower than or equal to 3.3%, and a determination result of “×” is given when the defect rate is higher than 3.3%.

The value of direct current to be applied is set to an appropriate value in accordance with the rated voltage or the breakdown voltage (BDV), and is set to 40 V in each of the present experimental examples. Furthermore, the rated voltage is 4 V.

A Cu diffusion distance is checked in accordance with a method described below.

Polishing is performed to the center in the second direction z so as to expose an LT cross section (i.e., a cross section taken in the stacking direction x and the first direction y). SEM observation is performed on the exposed LT cross section by using an electron microscope (SU8230 manufactured by Hitachi), and elemental analysis is performed by EDX (energy dispersive X-ray spectroscopy). Measurement conditions are indicated in Table 1. In this case, Cu and Ni are used as mapping elements. The mapping range is set to a region including 10 to 15 inner electrode layers 16 at an interface area of the multilayer body 12 near the center in the stacking direction x. At an interface position of the multilayer body 12 within an observation field, a maximum distance over which the intensity relationship between Cu and Ni continuously satisfies Cu/(Cu+Ni)>0.1 is calculated, and an average value of n=3 is set as a Cu diffusion distance. An area where the Cu intensity is 700 or greater is set as the base electrode layer 32, and the interface position of the multilayer body 12 is set as a boundary portion where the Cu intensity falls below 700.

An Ni diffusion distance is checked in accordance with a method described below.

Polishing is performed to the center in the second direction z so as to expose an LT cross section (i.e., a cross section taken in the stacking direction x and the first direction y). SEM observation is performed on the exposed LT cross section by using an electron microscope (SU8230 manufactured by Hitachi), and elemental analysis is performed by EDX (energy dispersive X-ray spectroscopy). Measurement conditions are indicated in Table 1. In this case, Cu and Ni are used as mapping elements. The mapping range is set to a region including 10 to 15 inner electrode layers 16 at an interface area of the multilayer body 12 near the center in the stacking direction x. At an interface position of the multilayer body 12 within an observation field, a maximum distance over which the intensity relationship between Cu and Ni continuously satisfies Ni/(Cu+Ni)>0.1 is calculated, and an average value of n=3 is set as an Ni diffusion distance. An area where the Cu intensity is 700 or greater is set as the base electrode layer 32, and the interface position of the multilayer body 12 is set as a boundary portion where the Cu intensity falls below 700.

An Ag diffusion distance is checked in accordance with a method described below.

Polishing is performed to the center in the second direction z so as to expose an LT cross section (i.e., a cross section taken in the stacking direction x and the first direction y). SEM observation is performed on the exposed LT cross section by using an electron microscope (SU8230 manufactured by Hitachi), and elemental analysis is performed by EDX (energy dispersive X-ray spectroscopy). Measurement conditions are indicated in Table 1. In this case, Cu, Ni, and Ag are used as mapping elements. The mapping range is set to a region including 10 to 15 inner electrode layers 16 at an interface area of the multilayer body 12 near the center in the stacking direction x. At an interface position of the multilayer body 12 within an observation field, an area where the Ag intensity is greater than 0 is set as an Ag segregation section. An area where the Cu intensity is 700 or greater is set as the base electrode layer 32, and the interface position of the multilayer body 12 is set as a boundary portion where the Cu intensity falls below 700.

TABLE 1

| | | | Measurement | Mapping |
|---|---|---|---|---|
| Acceleration | Current | W.D. | Time | Resolution |
| Voltage (kV) | Value (μA) | (mm) | (seconds) | (pixels) |
| 15 | 10 | 12 | 600 | 256 × 256 |

Evaluation Results are indicated in Table 2.

Table 2 indicates, with respect to the presence or absence of an Ag segregation section and variations in the baking temperature, the presence or absence of a crack in the multilayer ceramic capacitor according to each sample, the evaluation results of moisture resistance reliability, and the determination results of contact reliability.

TABLE 2

| | Presence or | | Ni | Cu | | Moisture- | |
|---|---|---|---|---|---|---|---|
| | Absence of Ag | Baking | Diffusion | Diffusion | | Resistance | |
| | Segregation | Temperature | Distance | Distance | | Reliability | Contact |
| | Section | (° C.) | (μm) | (μm) | Crack | Test | Reliability |
| Comparative | Absent | 700 | 0.2 | 1.1 | ∘ | ∘ | x |
| Example 1 | | | | | | | |
| Comparative | Absent | 750 | 0.5 | 1.6 | ∘ | ∘ | x |
| Example 2 | | | | | | | |
| Comparative | Absent | 800 | 0.9 | 3.5 | ∘ | ∘ | x |
| Example 3 | | | | | | | |
| Comparative | Absent | 850 | 2.8 | 5.0 | x | Δ | ∘ |
| Example 4 | | | | | | | |
| Comparative | Absent | 900 | 7.2 | 15.4 | x | x | ∘ |
| Example 5 | | | | | | | |
| Comparative | Present | 900 | 2.5 | 7.3 | x | Δ | ∘ |
| Example 6 | | | | | | | |
| Example 1 | Present | 700 | 0.1 | 0.5 | ∘ | ∘ | Δ |
| Example 2 | Present | 750 | 0.3 | 1.1 | ∘ | ∘ | Δ |
| Example 3 | Present | 800 | 0.5 | 1.2 | ∘ | ∘ | ∘ |
| Example 4 | Present | 850 | 1.2 | 3.2 | ∘ | ∘ | ∘ |

According to Table 2, in Example 1 to Example 4, an Ag segregation section is present in the connection region where an inner electrode layer connects to a base electrode layer, and the baking temperature is 850° C. or lower. Thus, the Ni diffusion distance and the Cu diffusion distance are relatively small at 1.2 μm or less and 3.2 μm or less, respectively. Accordingly, while contact reliability is ensured, the contact points between the base electrode layer and the inner electrode layer, which are complete solid solutions, are reduced, whereby mutual diffusion between Cu included in the base electrode layer and Ni included in the inner electrode layer is reduced or prevented. Consequently, it is confirmed that the occurrence of a crack inside the multilayer body 12 can be reduced or prevented, and that hydrogen-induced deterioration of insulation resistance can also be reduced.

In contrast, in Comparative Example 1 to Comparative Example 3, an Ag segregation section is absent in the connection region where the inner electrode layer connects to the base electrode layer, so that the contact reliability is poor.

In Comparative Example 4 and Comparative Example 5, an Ag segregation section is absent in the connection region where the inner electrode layer connects to the base electrode layer, and the Cu diffusion distance to the inner electrode layer is 5.0 μm or more. Thus, the volume of the inner electrode layer has increased, thus causing a crack to occur inside the multilayer body.

In Comparative Example 6, an Ag segregation section is present in the connection region where the inner electrode layer connects to the base electrode layer. However, since the baking temperature is 900° C. or higher, the Cu diffusion distance to the inner electrode layer is 5.0 μm or more. Thus, the volume of the inner electrode layer has increased, thus causing a crack to occur inside the multilayer body.

According to the above results, the Ag segregation section in which Ag is segregated is disposed at the connection region between the base electrode layer and the inner electrode layer, whereby contact points between the base electrode layer and the inner electrode layer, which are complete solid solutions, are reduced to reduce or prevent mutual diffusion, while contact reliability between the base electrode layer and the inner electrode layer via the Ag segregation section is ensured. Accordingly, it is apparent that expansion of the inner electrode layer can be reduced or prevented, thereby reducing or preventing cracks inside the multilayer body and reducing hydrogen-induced deterioration of insulation resistance.

Although the example embodiments of the present invention have been disclosed in the above description, the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers that are stacked and a plurality of inner electrode layers that are stacked on the dielectric layers, a first surface and a second surface that are opposed to each other in a stacking direction, a third surface and a fourth surface that are opposed to each other in a first direction orthogonal to the stacking direction, and a fifth surface and a sixth surface, a first inner electrode layer on the plurality of dielectric layers and extending to the third surface, a second inner electrode layer on the plurality of dielectric layers and extending to the fourth surface;
a first outer electrode on the third surface and connected to the first inner electrode layer; and
a second outer electrode on the fourth surface and connected to the second inner electrode layer; wherein
the first inner electrode layer includes a first exposed section exposed at the third surface;
the second inner electrode layer includes a second exposed section exposed at the fourth surface;
the first outer electrode and the second outer electrode each include Cu and Ag as metal components and a glass component;
at least one of an interface between the first outer electrode and the third surface or an interface between the second outer electrode and the fourth surface is provided with a glass layer; and
at least one of a connection region between the first outer electrode and the first exposed section or a connection region between the second outer electrode and the second exposed section is provided with an Ag segregation section where an Ag particle is segregated.

2. The multilayer ceramic capacitor according to claim 1, wherein
the Ag segregation section covers at least one of a portion of the first exposed section or a portion of the second exposed section;
the glass layer covers the Ag segregation section; and
the Cu covers the glass layer.

3. The multilayer ceramic capacitor according to claim 1, wherein
the Ag segregation section covers at least one of a portion of the first exposed section or a portion of the second exposed section; and
the Cu covers the Ag segregation section.

4. The multilayer ceramic capacitor according to claim 2, wherein an Ag concentration within an approximately 5 μm region from the third surface and the fourth surface is greater than an Ag concentration outside the approximately 5 μm region from the third surface and the fourth surface.

5. The multilayer ceramic capacitor according to claim 1, wherein the Ag segregation section has a thickness of about 1 μm or less.

6. The multilayer ceramic capacitor according to claim 1, wherein the Ag particle is distributed in a dot pattern outside an approximately 5 μm region from the third surface and the fourth surface.

7. The multilayer ceramic capacitor according to claim 1, wherein the multilayer body includes Sn layers between the first inner electrode layer and the dielectric layers and between the second inner electrode layer and the dielectric layers.

8. The multilayer ceramic capacitor according to claim 1, wherein each of the first outer electrode and the second outer electrode includes base electrode layers and plating layers.

9. The multilayer ceramic capacitor according to claim 8, wherein at least one of the base electrode layers directly covers the Ag segregation section.

10. The multilayer ceramic capacitor according to claim 1, wherein the multilayer ceramic capacitor is a two-terminal capacitor or a three-terminal capacitor.

11. A multilayer ceramic capacitor comprising:
a multilayer body including a plurality of dielectric layers that are stacked and a plurality of inner electrode layers that are stacked on the dielectric layers, a first surface and a second surface that are opposed to each other in a stacking direction, a third surface and a fourth surface that are opposed to each other in a first direction orthogonal to the stacking direction, and a fifth surface and a sixth surface that are opposed to each other in a second direction orthogonal to the stacking direction and the first direction;
a first inner electrode layer on the plurality of dielectric layers and extending to the third surface and the fourth surface;
a second inner electrode layer on the plurality of dielectric layers and extending to the fifth surface and the sixth surface;
a first outer electrode on the third surface and connected to the first inner electrode layer;
a second outer electrode on the fourth surface and connected to the first inner electrode layer;
a third outer electrode on the fifth surface and connected to the second inner electrode layer; and
a fourth outer electrode on the sixth surface and connected to the second inner electrode layer; wherein
the first inner electrode layer includes a first exposed section exposed at the third surface and a second exposed section exposed at the fourth surface;
the second inner electrode layer includes a third exposed section exposed at the fifth surface and a fourth exposed section exposed at the sixth surface;
the first outer electrode to the fourth outer electrode each include Cu and Ag as metal components and a glass component;
at least one of an interface between the first outer electrode and the third surface, an interface between the second outer electrode and the fourth surface, an interface between the third outer electrode and the fifth surface, or an interface between the fourth outer electrode and the sixth surface is provided with a glass layer; and
at least one of a connection region between the first outer electrode and the first exposed section, a connection region between the second outer electrode and the second exposed section, a connection region between the third outer electrode and the third exposed section, or a connection region between the fourth outer electrode and the fourth exposed section is provided with an Ag segregation section where an Ag particle is segregated.

12. The multilayer ceramic capacitor according to claim 11, wherein
the Ag segregation section covers at least one of a portion of the first exposed section, a portion of the second exposed section, a portion of the third exposed section, or a portion of the fourth exposed section;
the glass layer covers the Ag segregation section; and
the Cu covers the glass layer.

13. The multilayer ceramic capacitor according to claim 11, wherein
the Ag segregation section covers at least one of a portion of the first exposed section, a portion of the second exposed section, a portion of the third exposed section, or a portion of the fourth exposed section; and
the Cu covers the Ag segregation section.

14. The multilayer ceramic capacitor according to claim 11, wherein an Ag concentration within an approximately 5 μm region from the third surface, the fourth surface, the fifth surface, and the sixth surface is greater than an Ag concentration outside the approximately 5 μm region from the third surface, the fourth surface, the fifth surface, and the sixth surface.

15. The multilayer ceramic capacitor according to claim 11, wherein the Ag segregation section has a thickness of about 1 μm or less.

16. The multilayer ceramic capacitor according to claim 11, wherein the Ag particle is distributed in a dot configuration outside an approximately 5 μm region from the third surface, the fourth surface, the fifth surface, and the sixth surface.

17. The multilayer ceramic capacitor according to claim 11, wherein the multilayer body includes Sn layers between the first inner electrode layer and the dielectric layers and between the second inner electrode layer and the dielectric layers.

18. The multilayer ceramic capacitor according to claim 11, wherein each of the first outer electrode and the second outer electrode includes base electrode layers and plating layers.

19. The multilayer ceramic capacitor according to claim 18, wherein at least one of the base electrode layers directly covers the Ag segregation section.

20. The multilayer ceramic capacitor according to claim 11, wherein the multilayer ceramic capacitor is a two-terminal capacitor or a three-terminal capacitor.
